(19) United States
(12) Patent Application Publication
(10) Pub. No.: US 2026/0153604 A1
(43) Pub. Date: Jun. 4, 2026

(54) LIDAR RANGE DATA PREPROCESSING

(71) Applicant: Liturex (Guangzhou) Co. Ltd., Guangzhou (CN)

(72) Inventor: Ximing Ren, Boise, ID (US)

(21) Appl. No.: 18/968,298

(22) Filed: Dec. 4, 2024

(51) Int. Cl. G01S 7/487; G01S 7/4863

(52) U.S. Cl. CPC G01S 7/4876; G01S 7/4863; G01S 7/4873

(57) ABSTRACT

Apparatuses, systems, and methods to reduce data volume to be transmitted in a light detection and ranging (LiDAR) device. For example, at least one embodiment pertains to a LiDAR device that comprises one or more circuits to generate statistical measurements of photon detection events and transmit the statistical measurements to a data processing unit for further processing.

### TECHNICAL FIELD

Apparatuses, systems, and methods to reduce data throughout. For example, at least one embodiment pertains to using a circuitry to preprocessing data to reduce data volume from a receiver in a light detection and ranging (LiDAR) device.

### BACKGROUND

For light detection and ranging (LiDAR) devices, improving the signal-to-noise ratio (SNR) is useful, for example, it can increase the detection range of a LiDAR device. While multiple shots or exposures of detectors can improve the SNR, it generates significantly more data, which causes higher power consumption, high data throughput, and the need for more powerful chips to process the data.

### BRIEF DESCRIPTION OF THE DRAWINGS

Embodiments of the disclosure are illustrated by way of example and not limitation in the figures of the accompanying drawings, in which like references indicate similar elements.

FIG. 1 is a block diagram illustrating a LiDAR device in which embodiments of the disclosure are implemented in accordance with an embodiment;

FIG. 2 illustrates an algorithm 200 of reducing photodetector data throughput in accordance with an embodiment; and

FIG. 3 is a block diagram illustrating a process for reducing photodetector data throughput in accordance with an embodiment.

### DETAILED DESCRIPTION

In the following description, numerous specific details are set forth to provide a more thorough understanding of at least one embodiment. However, it will be apparent to one skilled in the art that the inventive concepts may be practiced without one or more of these specific details.

Apparatuses, systems, and methods to reduce range data volume to be transmitted in a light detection and ranging (LiDAR) device. For example, at least one embodiment pertains to a LiDAR device that comprises one or more circuits to generate summary data (e.g., statistical measurements) of photon detection events and transmit the summary data to a data processing unit for further processing.

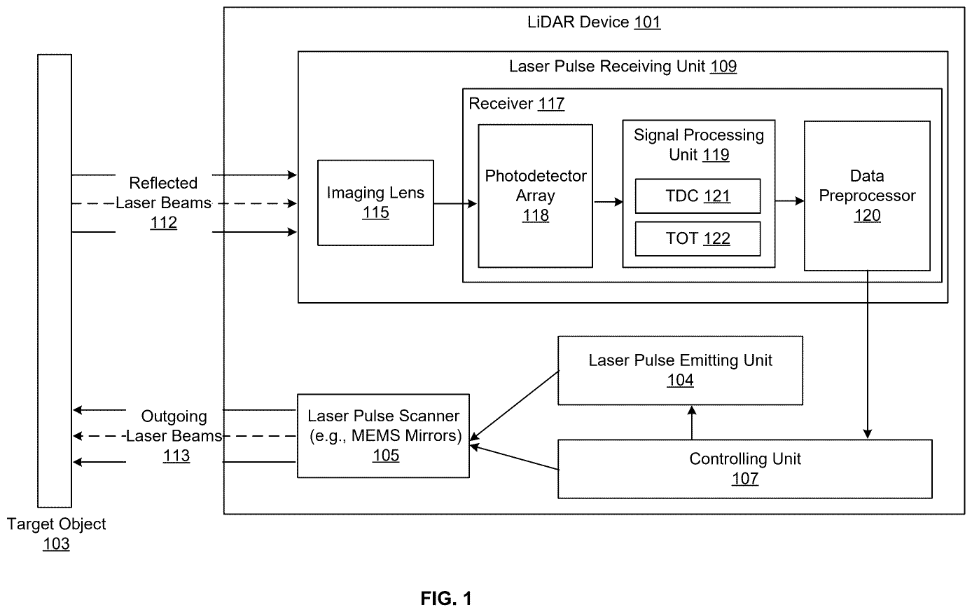

FIG. 1 is a block diagram illustrating a LiDAR device 101 in which embodiments of the disclosure are implemented in accordance with an embodiment. In at least one embodiment, LiDAR device 101 can be a solid-state LiDAR system, which includes a laser pulse emitting unit 104, a laser pulse scanner 105, a laser pulse receiving unit 109, and a controlling unit 107.

In at least one embodiment, laser pulse emitting unit 104 includes one or more laser emitters that emit beams 113 of pulses of laser light. In at least one embodiment, beams 113 can be steered or scanned by laser pulse scanner 105 using mechanisms, such as a MEMS mirror and an optical phased array (OPA).

In at least one embodiment, controlling unit 107 includes control logic implemented in hardware, software, firmware, or a combination thereof. In at least one embodiment, controlling logic 107 drives other units or subsystems of LiDAR system 101 and executes or otherwise performs one or more operations to process range data generated by a receiver 117.

In at least one embodiment, controlling unit 107 consists of physical electronic components, such as microprocessors, microcontrollers, or custom integrated circuits (e.g., ASICs or FPGAs). In at least one embodiment, these components can execute tasks at high speeds, manage range data transfers, and control essential timing operations in LiDAR system 101. In at least one embodiment, controlling unit 107 can implement one or more algorithms and protocols to guide the behavior of LiDAR system 101. In at least one embodiment, these algorithms enable the controlling unit to perform complex calculations, manage data sequences, and adapt to different scanning or detection scenarios.

In at least one embodiment, laser light receiving unit 109 receives beams of laser pulses 112 reflected from a target object 103 on one or more imaging lenses 111 and directs the beams on receiver 117. In at least one embodiment, receiver 117 is a chip holding a photodetector array 118, a signaling processing unit 119, and a data preprocessor 120. In at least one embodiment, photodetector array 118 includes a plurality of high-sensitivity photodiodes, such as linear-mode avalanche-photodiode (APDs) and single-photon avalanche diodes (SPADs).

In at least one embodiment, photodetector array 118 converts incoming photons into electrical signals. In at least one embodiment, signal processing unit 119 is a circuitry consisting of various electronic components that processes electrical signals generated by photodetector array 118.

In at least one embodiment, signal processing unit 119 includes a Time to Digital Converter (TDC) function 121 which measures the time it takes for a photon to travel from LiDAR device 101 to target object 103 and back. In at least one embodiment, TDC function 121 uses an internal oscillator or clock to count the number of clock cycles that occur while the photon travels to target object 103 and back, and converts this count into a digital signal corresponding to the time interval. In at least one embodiment, signal processing unit 119 further includes a Time Over Threshold (TOT) function 122 that measures the duration that an electronic pulse generated by a detected photon stays above a set threshold.

In at least one embodiment, range data, such as TDC data and TOT data, generated by signal processing unit 119 can be transmitted to data preprocessor 120. In at least one embodiment, data preprocessor 120 is integrated with receiver 117. In at least one embodiment, data preprocessor 120 comprises a circuitry on the same chip that holds photodetector array 118 and signal processing unit 119. In at least one embodiment, each photodetector (e.g., a SPAD) in photodetector array 118 carries its own TDC and/or TOT (e.g., TDC 121 and TOT 122). In at least one embodiment, data preprocessor 120 is not on the same chip that holds photodetector array 118 but is connected with the chip via high-speed communication interfaces, such as LVDS (Low Voltage Differential Signaling), SPI (Serial Peripheral Interface), MIPI (Mobile Industry Processor Interface), or other high-bandwidth protocols designed to handle rapid range data transfer with minimal latency.

In at least one embodiment, the circuitry comprises one or more circuits for preprocessing the TDC data and TOT data. In at least one embodiment, data preprocessor 120 calculates statistical measures of this data and transmit the statistical measures to controlling unit 107. In at least one embodiment, data transmission from receiver 117 and controlling unit 107 can occur over high-speed communication interfaces, such as LVDS (Low Voltage Differential Signaling), SPI (Serial Peripheral Interface), MIPI (Mobile Industry Processor Interface), or other high-bandwidth protocols designed to handle rapid data transfer with minimal latency.

In at least one embodiment, data preprocessor 120 can be one of a plurality of types of circuitry, including ASIC(Application-Specific Integrated Circuit), FPGA (Field-Programmable Gate Array), Microcontrollers), DSP (Digital Signal Processor), General-Purpose GPU (Graphics Processing Unit), and PLD (Programmable Logic Device).

In at least one embodiment, by preprocessing TDC data and TOT data, data preprocessor 120 can significantly reduce the volume of data that needs to be transmitted to controlling unit 107. In at least one embodiment, with the data preprocessor 120, the LiDAR device 101 needs to provide memory that is large enough to store TDC values and/or TOT values from each exposure that are known based on, e.g., the sampling rate of LiDAR Device 101. In at least one embodiment, the requirement for smaller memory results in the smaller size of LiDAR device 101. In at least one embodiment, placing data preprocessor 120 and photodetector array 118 on the same chip causes LiDAR device 101 allows LiDAR device 101 to reduce the volume of range data that needs to be transmitted to controlling unit 107, which results in less power consumption for LiDAR device 101.

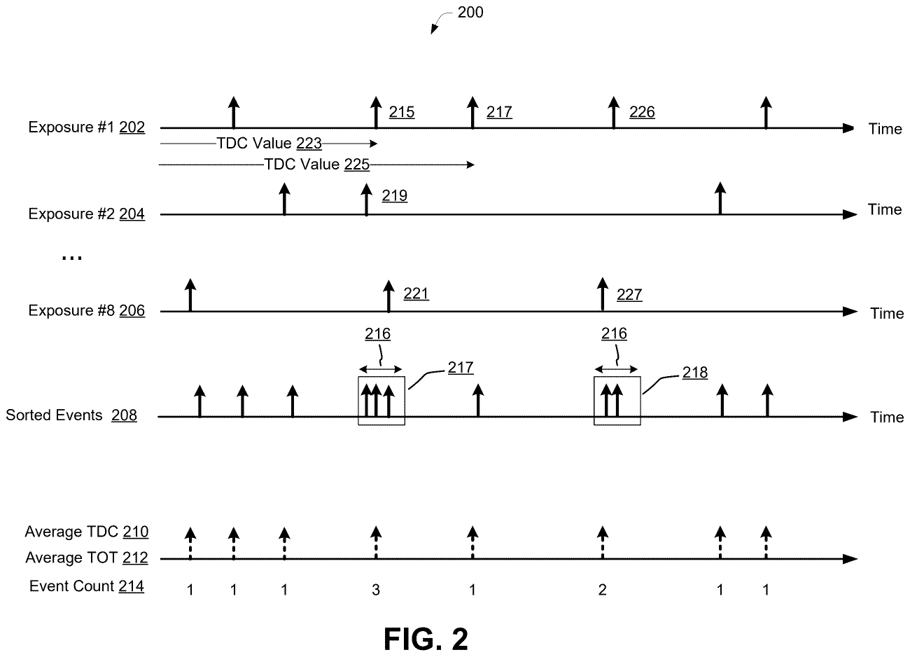

FIG. 2 illustrates an algorithm 200 of reducing photodetector data throughput in accordance with an embodiment. In at least one embodiment, algorithm 200 can be performed by a data preprocessor, such as data preprocessor 120 as described in connection with FIG. 1.

In at least one embodiment, 8 exposures 301 are used to illustrate algorithm 200. In at least one embodiment, an exposure is a single instance where a LiDAR device (e.g., LiDAR device 101 as described in connection with FIG. 1) detects and records photons that bounces back from a target after the being hit by a laser pulse. In at least one embodiment, when the laser emits a pulse, it travels to the target object, reflects off it, and some of that reflected light returns to the LiDAR device, which then captures or “exposes” this return signal, marking one instance of data collection about that target. In at least one embodiment, each exposure helps build a detailed 3D picture of the surroundings by measuring the time it takes for the pulse to return, which translates into the distance and other spatial data of the target object.

In at least one embodiment, these 8 exposures 301 are taken in one measurement cycle. In at least one embodiment, the LiDAR device can set the measurement cycle length to balance accuracy, speed, and data quality. In at least one embodiment, the LiDAR device can perform multiple measurement cycles during operation.

In at least one embodiment, the data preprocessor can receive TDC data and TOT data for each photon detection event in the 8 exposures. In at least one embodiment, a photon detection event is an occurrence when a photon is detected by a photodetector, such as a photodetector in photodetector array 118 as described in connection with FIG. 1.

In at least one embodiment, for example, photon detection event 215 has a TDC value 223, and photon detection event 217 has a TDC value 225. In at least one embodiment, each of these two events 215 and 217 also has a TOT value. In at least one embodiment, similarly, each other photon detection event has a TDC value and a TOT value.

In at least one embodiment, after receiving data for all the photon detection events in the 8 exposures 202, 204, 206, the data preprocessor accumulates all the photon detection events into a list. In at least one embodiment, the data preprocessor can also sort these accumulated events using a sorting algorithm (e.g., Quick Sort) based on their TDC values to create a list of sorted events 208. In at least one embodiment, the list of events 208 can be ordered in a descending order. In at least one embodiment, the list of events 208 can be ordered in an ascending order. In at least one embodiment, the data preprocessor can also group these accumulated events into different groups.

In at least one embodiment, the data preprocessor can search for events with similar TDC values. In at least one embodiment, the data preprocessor can use a TDC window to locate these events. In at least one embodiment, a TDC window is a window of duration (e.g., 0.3 nanoseconds). In at least one embodiment, the data preprocessor can identify photon detection events with TDC values whose differences are smaller than the window as a cluster. In at least one embodiment, for example, if photon detection event A has a TDC value of 50 nanoseconds, photon detection event B has a TDC value of 50.1 nanoseconds, and photon detection event C has a TDC value of 50.15 nanoseconds, the three events (A, B, and C) can be identified as a cluster, because the TDC value difference between any two events among the events A, B, and C is smaller than the TDC window (i.e., 0.3 nanoseconds).

In at least one embodiment, photon detection events 215, 219, 229 are identified as a cluster 217 using a TDC window 216. In at least one embodiment, similarly, photon detection events 226, 227 are identified as a cluster 218 using the same TDC window 216. In at least one embodiment, the number of events that fit into the TDC window is adjustable. In at least one embodiment, the number can be any number, such as 2, 3 or 5. In at least one embodiment, the size of the TDC window can also be adjustable. In at least one embodiment, the size of the window can be 0.1 nanoseconds, 0.2 nanoseconds, 0.3 nanoseconds, or any other size.

In at least one embodiment, the data preprocessor starts with the first photon detection event and determines whether the difference between the TDC value of the first event and the TDC value of a second event is smaller than the size of the TDC window. In at least one embodiment, if the difference is smaller than the TDC window, the data preprocessor can group these two events together. In at least one embodiment, the data preprocessor then determines whether the difference between TDC values of the first and the third events is smaller than the size of the TDC window. In at least one embodiment, if that difference is smaller than the size of the TDC window, the data preprocessor groups the third event with the first and the second events. In at least one embodiment, the process can continue in a similar manner until the data preprocessor encounters an event whose TDC value differs from that of the first event by a value that is not smaller than the size of the TDC window. In at least one embodiment, the data preprocessor then starts with the event whose TDC value differs from that of the first event by a value that is not smaller than the size of the TDC window, and repeats the process described above until all the events in the sorted events 208 are processed.

In at least one embodiment, only clusters with a size that exceeds a threshold can have their data (e.g., average TDC value, average TOT value, and event count) output to a data processing unit (e.g., controlling unit 107 as described in connection with FIG. 1). In at least one embodiment, those clusters whose size does not exceed the threshold will be discarded, along with those single events that cannot be grouped with any other events.

In at least one embodiment, the data preprocessor, instead of outputting data of all the originally recorded events in the 8 exposures, outputs statistical measurements of just one or more clusters that meet predetermined requirements, significantly reducing data throughput that needs to be transmitted to the data processing unit.

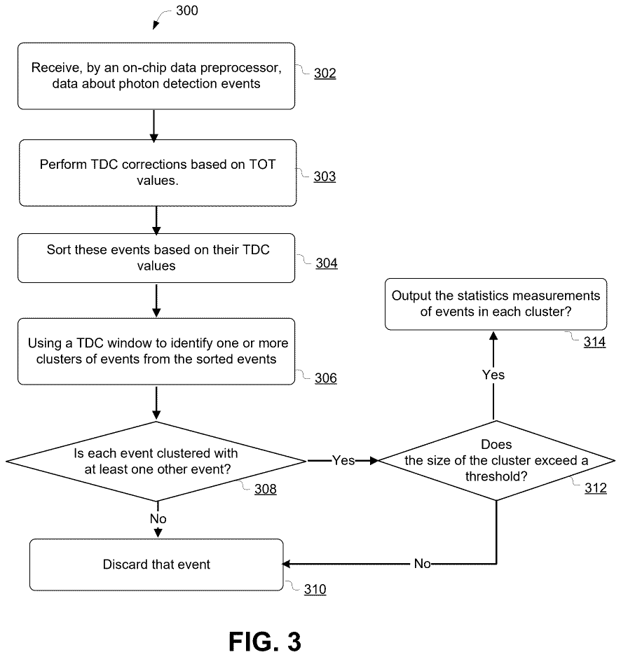

FIG. 3 is a block diagram illustrating a process 300 for reducing photodetector data throughput in accordance with an embodiment. In at least one embodiment, process 300 is performed by processing logic comprising hardware, software, or a combination of both. In some embodiments, process 300 may be performed by an on-chip circuitry, such as the data preprocessor 120, as described in connection with FIG. 1.

In at least one embodiment, at step 302, the processing logic receives data about photon detection events. In at least one embodiment, this data includes Time to Digital Converter (TDC) values for time-of-flight measurements and Time Over Threshold (TOT) values for signal intensity. In at least one embodiment, this data is collected over multiple exposures (e.g., 8 exposures per measurement cycle).

In at least one embodiment, at step 303, the processing logic performs TDC corrections based on TOT values to remove range walk effects. In at least one embodiment, range walk is a phenomenon in LIDAR systems that affects the accuracy of distance measurements, and it occurs due to variations in the intensity of reflected light from a target. LIDAR systems measure distances by calculating the time it takes for a light pulse to travel to a target object and return, but this measurement assumes the pulse shape and time of flight are consistent. However, when targets have varying reflectivity or distance, the received pulse's intensity and shape can change. For example, closer or more reflective targets may return stronger signals earlier, while weaker signals from farther or less reflective targets may be delayed. In at least one embodiment, the effects of range walk can be removed through calibration, where the quantitative relationship between the pulse amplitude and the timing offset is determined.

In at least one embodiment, at step 304, the processing logic sorts these events based on their TDC values. In at least one embodiment, the TOT values have been corrected to remove range walk effects.

In at least one embodiment, at step 306, the processing logic uses a TDC window to identify one or more clusters of events from the list of accumulative events. In at least one embodiment, the processing logic applies a TDC window to group events with similar TDC values. In at least one embodiment, the TDC window is a predefined time interval (e.g., 0.3 nanoseconds). In at least one embodiment, the processing logic moves through the sorted list of events and groups events whose TDC values differ by less than the size of the TDC window.

In at least one embodiment, at step 308, the processing logic checks whether each photon detection event is part of a cluster with at least one other event. In at least one embodiment, clustering events helps reduce noise by isolating meaningful signal patterns, which are more likely to consist of multiple events occurring close together in time. In at least one embodiment, if an event cannot be clustered with any other events (meaning it is an isolated detection), it is likely considered noise or an outlier. In such cases, the processing logic proceeds to step 310, where unclustered events are discarded.

In at least one embodiment, at step 312, the processing logic checks whether the size of each cluster exceeds a threshold. In at least one embodiment, this check ensures that only clusters with a sufficient number of photon detection events are considered for further processing. In at least one embodiment, if a cluster has fewer events than the specified threshold, it is assumed to be too small to represent a significant detection and is discarded. In at least one embodiment, for example, if the threshold is set to two events, only clusters with three or more events will be processed. In at least one embodiment, this thresholding helps the processing logic focus on the most relevant data, discarding smaller clusters that may be less reliable or indicative of noise.

In at least one embodiment, at step 314, the processing logic outputs statistical measurements of events in each cluster whose size exceeds the threshold. In at least one embodiment, the processing logic calculates the statistical measurements (such as the average TDC value, average TOT value, and event count) and outputs these measurements to a data processing unit, such as controlling unit 107, as described in connection with FIG. 1.

At least one embodiment of the disclosure can be described in view of the following clauses:
1. A light detection and ranging (LiDAR) device, comprising: one or more circuits to generate statistical measurements of photon detection events and transmit the statistical measurements to a data processing unit for further processing.
2. The LiDAR device of clause 1, wherein the one or more circuits are on a same chip with one or more photodetectors of the LiDAR device.
3. The LiDAR device of clause 1 or 2, wherein the statistical measurements include an average value of Time-to-Digital converter (TDC) values of one or more photon detection events, an average value of Time-Over-Threshold (TOT) values of one or more photon detection events, and a count of one or more photon detection events.
4. The LiDAR device of any of clauses 1-3, wherein the photon detection events are collected over multiple exposures in a measurement cycle.
5. The LiDAR device of any of clauses 1-4, wherein the photon detection events are in one or more clusters that each have a size exceeding a threshold.
6. The LiDAR device of any of clauses 1-5, wherein the data processing unit is connected with the one or more circuits via high-speed communication interfaces.
7. The LiDAR device of any of clauses 1-6, wherein the photon detection events are accumulated into a list of events.
8. The LiDAR device of any of clauses 1-7, wherein the photon detection events are grouped into different clusters using a predetermined window of time.
9. The LiDAR device of any of clauses 1-8, wherein the photon detection events are events that remain that after one or more photodetection events collected from multiple exposures in a measurement cycle have been discarded.
10. The LiDAR device of any of clauses 1-9, wherein the photon detection events are selected from a plurality of photon detection events that are ordered based on their Time-to-Digital Converter (TDC) values in ascending order.
11. A method of reducing data throughput in a light detection and ranging (LiDAR) device, comprising:
   generating, using one or more circuits, statistical measurements of photon detection events; and
   transmit, using one or more circuits, the statistical measurements to a data processing unit for further processing.
12. The method of clause 11, wherein the one or more circuits are on a same chip with one or more photodetectors of the LiDAR device.
13. The method of clause 11 or 12, wherein the statistical measurements include an average value of Time-to-Digital converter (TDC) values of one or more photon detection events, an average value of Time-Over-Threshold (TOT) values of one or more photon detection events, and a count of one or more photon detection events.
14. The method of any of clauses 11-13, wherein the photon detection events are collected over multiple exposures in a measurement cycle.
15. The method of any of clauses 11-14, wherein the photon detection events are in one or more clusters that each have a size exceeding a threshold.
16. The method of any of clauses 11-15, wherein the data processing unit is connected with the one or more circuits via high-speed communication interfaces.
17. The method of any of clauses 11-16, wherein the photon detection events are selected from a plurality of photon detection events that are sorted using a sorting algorithm based on their Time-to-Digital Converter (TDC) values.
18. The method of any of clauses 11-17, wherein the photon detection events are grouped into different clusters using a predetermined window of time.
19. The method of any of clauses 11-18, wherein the photon detection events are events that remain that after one or more photodetection events collected from multiple exposures in a measurement cycle have been discarded.
20. The method of any of clauses 11-19, wherein the photon detection events are selected from a plurality of photon detection events that are ordered based on their Time-to-Digital Converter (TDC) values in ascending order.

In particular embodiments, certain features described herein in the context of separate implementations or embodiments may also be combined and implemented in a single implementation or embodiment. Conversely, various features that are described in the context of a single implementation or embodiment may also be implemented in multiple implementations or embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layout of the devices illustrated.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B or C” means at least one of the following: A; B; C; A and B; A and C; B and C; A, B and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by ±0.5%, ±1%, ±2%, ±3%, ±4%, ±5%, ±10%, ±12%, or ±15%. As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

Some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

All of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A light detection and ranging (LiDAR) device, comprising: one or more circuits to generate statistical measurements of photon detection events and transmit the statistical measurements to a data processing unit for further processing.

2. The LiDAR device of claim 1, wherein the one or more circuits are on a same chip with one or more photodetectors of the LiDAR device.

3. The LiDAR device of claim 1, wherein the statistical measurements include an average value of Time-to-Digital converter (TDC) values of one or more photon detection events, an average value of Time-Over-Threshold (TOT) values of one or more photon detection events, and a count of one or more photon detection events.

4. The LiDAR device of claim 1, wherein the photon detection events are collected over multiple exposures in a measurement cycle.

5. The LiDAR device of claim 1, wherein the photon detection events are in one or more clusters that each have a size exceeding a threshold.

6. The LiDAR device of claim 1, wherein the data processing unit is connected with the one or more circuits via high-speed communication interfaces.

7. The LiDAR device of claim 1, wherein the photon detection events are accumulated into a list of events.

8. The LiDAR device of claim 1, wherein the photon detection events are grouped into different clusters using a predetermined window of time.

9. The LiDAR device of claim 1, wherein the photon detection events are events that remain that after one or more photodetection events collected from multiple exposures in a measurement cycle have been discarded.

10. The LiDAR device of claim 1, wherein the photon detection events are selected from a plurality of photon detection events that are ordered based on their Time-to-Digital Converter (TDC) values in ascending order.

11. A method of reducing data throughput in a light detection and ranging (LiDAR) device, comprising:
generating, using one or more circuits, statistical measurements of photon detection events; and
transmit, using one or more circuits, the statistical measurements to a data processing unit for further processing.

12. The method of claim 11, wherein the one or more circuits are on a same chip with one or more photodetectors of the LiDAR device.

13. The method of claim 11, wherein the statistical measurements include an average value of Time-to-Digital converter (TDC) values of one or more photon detection events, an average value of Time-Over-Threshold (TOT) values of one or more photon detection events, and a count of one or more photon detection events.

14. The method of claim 11, wherein the photon detection events are collected over multiple exposures in a measurement cycle.

15. The method of claim 11, wherein the photon detection events are in one or more clusters that each have a size exceeding a threshold.

16. The method of claim 11, wherein the data processing unit is connected with the one or more circuits via high-speed communication interfaces.

17. The method of claim 11, wherein the photon detection events are accumulated into a list of events.

18. The method of claim 11, wherein the photon detection events are grouped into different clusters using a predetermined window of time.

19. The method of claim 11, wherein the photon detection events are events that remain that after one or more photodetection events collected from multiple exposures in a measurement cycle have been discarded.

20. The method of claim 11, wherein the photon detection events are selected from a plurality of photon detection events that are ordered based on their Time-to-Digital Converter (TDC) values in ascending order.
